(19) United States
(12) Patent Application Publication
(10) Pub. No.: US 2014/0087265 A1
(43) Pub. Date: Mar. 27, 2014

(54) CATHODE ACTIVE MATERIAL FOR A LITHIUM ION SECONDARY BATTERY AND A LITHIUM ION SECONDARY BATTERY

(71) Applicant: NGK INSULATORS, LTD., Nagoya-City (JP)

(72) Inventors: Yukinobu YURA, Nagoya-City (JP); Chiori SUZUKI, Nagoya-City (JP); Ryuta SUGIURA, Toyohashi-City (JP); Nobuyuki KOBAYASHI, Nagoya-City (JP)

(73) Assignee: NGK INSULATORS, LTD., Nagoya-City (JP)

(21) Appl. No.: 13/626,212

(22) Filed: Sep. 25, 2012

(51) Int. Cl. H01M 4/131

(52) U.S. Cl. CPC H01M 4/131
USPC 429/231.1; 429/209

(57) ABSTRACT

A cathode active material for a lithium secondary battery, includes secondary particles, each being formed of a large number of primary particles whose mean particle size is equal to or larger than 0.01 μm and equal to or smaller than 5 μm, and includes the following features. An oriented ratio of a (003) plane is equal to or larger than 60%. A mean particle size is equal to or larger than 1 μm and equal to or smaller than 100 μm. An aspect ratio is equal to or larger than 1.0 and is smaller than 2. A voidage is equal to or larger than 3% and equal to or smaller than 30%. A ratio of opened pore is equal to or larger than 70%. A mean pore size of the opened pore is equal to or larger than 0.1 μm and equal to or smaller than 5 μm.

### TECHNICAL FIELD

The present invention relates to a cathode active material having a layered rock salt structure for a lithium secondary battery. The present invention also relates to a lithium secondary battery using the cathode active material.

### BACKGROUND ART

A cathode active material using a lithium composite oxide (lithium/transition-metal composite oxide) having a layered rock salt structure as a cathode active material for a lithium secondary battery (which may be referred to as a lithium ion secondary battery) has been widely known (refer to, for example, Patent Literature No. 1, and Patent Literature No. 2).

In this type of the cathode active material, it has been known that a lithium ion (Li⁺) diffusion inside of the material occurs in-plane directions of the (003) plane (i.e., any directions in a plane parallel to the (003) plane), and intercalation and deintercalation of lithium ions occur through a crystal plane other than the (003) plane (e.g., the (101) plane, or the (104) plane).

In view of the above, attempts have been made in the cathode active material of this kind to have/make the crystal plane through which the intercalation and the deintercalation of lithium ions readily occur (other than the (003) plane: for example, the (101) plane, or the (104) plane) be exposed to a surface contacting with an electrolyte, as much extent as possible, in order to improve the cell characteristics (refer to, for example, Patent Literature No. 3).

Further, the cathode active material of this kind in which pores (that may also be referred to as holes or voids) are formed has been known (refer to, for example, Patent Literature Nos. 4, 5 and 6).

### CITATION LIST

### Patent Literature

[Patent Literature No. 1] Japanese Patent Application Laid-Open (kokai) No. Hei 5-226004.
[Patent Literature No. 2] Japanese Patent Application Laid-Open (kokai) No. 2003-132887.
[Patent Literature No. 3] International Publication WO 2010/074304.
[Patent Literature No. 4] Japanese Patent Application Laid-Open (kokai) No. 2002-75365.
[Patent Literature No. 5] Japanese Patent Application Laid-Open (kokai) No. 2004-83388.
[Patent Literature No. 6] Japanese Patent Application Laid-Open (kokai) No. 2009-117241.

### SUMMARY OF INVENTION

There has been an increasing demand to improve the cell characteristics of the lithium secondary battery, especially a discharge characteristic at high-rate (hereinafter, simply referred to as an “output characteristic”), and a discharge capacity at high-rate (hereinafter, simply referred to as an “rate characteristic”). The present invention is made to provide a cathode active material of this kind which has more improved characteristics.

The cathode active material of the lithium secondary battery (hereinafter, referred to as a “cathode active material of the present invention”) according to the present invention has a layered rock salt structure, and the following features.

(1) The cathode active material includes secondary particles, each being formed of a large number of primary (initial) particles whose mean particle size is equal to or larger than 0.01 μm and equal to or smaller than 5 μm.
(2) The secondary particle has the following features.

An oriented ratio of the (003) plane is equal to or larger than 60% (preferably equal to or larger than 75%).

A mean particle size is equal to or larger than 1 μm and equal to or smaller than 100 μm.

An aspect ratio obtained through dividing a size/dimension parallel to a longitudinal axis by a size/dimension parallel to a short axis is equal to or larger than 1.0 and is smaller than 2.

A voidage (porosity) is equal to or larger than 3% and equal to or smaller than 30%.

A ratio of opened pore is equal to or larger than 70%.

A mean pore size of opened pore is equal to or larger than 0.1 μm and equal to or smaller than 5 μm.

A value obtained through dividing the mean particle size of the primary particle by the mean pore size of the opened pore is equal to or larger than 0.1 and equal to or smaller than 5.

The lithium secondary battery according to the present invention comprises a cathode including a cathode active material layer, and an anode including an anode active material layer. In the lithium secondary battery according to the present invention, the cathode active material layer includes the cathode active material which is formed as the secondary particle wherein a large number of the primary particles (single-crystalline primary particles made of lithium composite oxide having a layered rock salt structure) congregate.

The “layered rock salt structure” refers to a crystal structure in which lithium layers and layers of a transition metal other than lithium are arranged in alternating layers with an oxygen layer therebetween (typically, α-NaFeO₂ type structure: structure in which a transition metal and lithium are arrayed orderly in the direction of the [111] axis of a cubic rock salt type structure).

Typically, lithium cobaltate (LiCoO₂) can be used as the lithium composite oxide having a layered rock salt structure which constitutes the cathode active material of the present invention. It should be noted that a solid solution containing nickel, manganese, etc., in addition to cobalt can be used as the lithium composite oxide which constitutes the cathode active material of the present invention. Specifically, lithium nickelate, lithium manganate, lithium nickelate manganate, lithium nickelate cobaltate, lithium cobaltate nickelate manganate, lithium cobaltate manganate, and the like can be used as the lithium composite oxide which constitutes the cathode active material of the present invention. These materials may contain one or more elements of Mg, Al, Si, Ca, Ti, V, Cr, Fe, Cu, Zn, Ga, Ge, Sr, Y, Zr, Nb, Mo, Ag, Sn, Sb, Te, Ba, Bi, etc.

Specifically, for example, materials expressed according to composition formulas described below can be used as the lithium composite oxide which constitutes the cathode active material of the present invention.

LiₚMeO₂ Composition Formula (1):

(In the above formula (1), 0.9≦p≦1.3, Me represents at least one kind of metal elements selected from a group of Mn, Ti, V, Cr, Fe, Co, Ni, Cu, Al, Mg, Zr, B, and Mo.)

xLi₂MO₃−(1−x)LiₚMeO₂ Composition Formula (2):

(In the above formula (2), 0<x<1, and 0.9≦p≦1.3. M and Me are independent from each other, and each represents at least one kind of metal elements selected from a group of Mn, Ti, V, Cr, Fe, Co, Ni, Cu, Al, Mg, Zr, B, and Mo.)

The “Me” in the above formulas (1) and (2) may be at least one kind of metal elements, each having a mean oxidation state “+3”, and preferably, at least one kind of metal elements selected from a group of Mn, Ni, Co, and Fe. The “M” in the above formula (2) may be at least one kind of metal elements, each having a mean oxidation state “+4”, and preferably, at least one kind of metal elements selected from a group of Mn, Zr, and Ti.

The cathode active material of nickel-cobalt-aluminum series suitably used in the present invention has a composition expressed by a general formula described below.

Liₚ(Niₓ,Co_{y},Al_{z})O₂ General Formula:

(In the above general formula, 0.9≦p≦1.3, 0.6<x≦0.9, 0.05≦y≦0.25, 0≦z≦0.2, and x+y+z=1)

In the general formula described above, a preferable range for p is 0.9≦p≦1.3, and a more preferable range for p is 1.0≦p≦1.1. If p is smaller than 0.9, the discharge capacity decreases, and thus p which is smaller than 0.9 is not preferable. If p is larger than 1.3, the discharge capacity decreases or an amount of gas generated in the cell (battery) while charging becomes large, and thus p which is larger than 1.3 is not preferable.

In the general formula described above, if x is smaller than 0.6, the discharge capacity decreases, and thus, x which is smaller than 0.6 is not preferable. If x is larger than 0.9, stability is deteriorated, and thus, x which is larger than 0.9 is not preferable. x is preferably 0.7-0.85.

In the general formula described above, if y is smaller than 0.05, the crystal structure becomes unstable, and thus, y which is smaller than 0.05 is not preferable. If y is larger than 0.25, the discharge capacity decreases, and thus, y which larger than 0.25 is not preferable. y is preferably 0.10-0.20.

In the general formula described above, if z is larger than 0.2, the discharge capacity decreases, and thus, z which larger than 0.2 is not preferable. z is preferably 0.01-0.1.

The “primary particle” means a particle which can be present (exist) by itself without forming an aggregate. Especially, the “single-crystalline primary particle” means the primary particle which does not include/contain a crystal grain boundary in its inside. In contrast, the “secondary particle” means a particle which is formed by an aggregation of the primary particles, or by an aggregation of a plurality (a large number of) the single-crystalline primary particles.

The “mean particle size” means an average of a diameter of a particle. The “diameter” is typically a diameter of a sphere, when the particle is assumed to be the sphere having the same volume or the same cross-sectional area as the particle. It should be noted the “mean” value is preferably calculated based on the number. For example, the mean particle size of the primary particle can be obtained by observing a surface of the secondary particle or a sectional view of the secondary particle using an electron scanning microscope (SEM).

The “oriented ratio of the (003) plane” means an oriented ratio (expressed by a percentage) of the (003) plane in the secondary particle. That is, when the oriented ratio of the (003) plane in the secondary particle is 60%, 60% of a large number of the (003) planes ((003) plane in the layered rock salt structure) included in the secondary particle are parallel to each other. Accordingly, it can be said that, as the oriented ratio of the (003) plane becomes higher, the degree of orientation of the (003) planes in the secondary particle becomes higher (specifically, a great number of the single-crystalline primary particles forming the secondary particle are provided in such a manner that the (003) planes of the primary particles are parallel to each other to a maximum extent). In contrast, it can be said that, as the oriented ratio of the (003) plane becomes lower, the degree of orientation of the (003) planes in the secondary particle becomes lower (specifically, a great number of the single-crystalline primary particles forming the secondary particle are provided in such a manner that the (003) planes of the primary particles are oriented in a dispersed (un-uniformed) fashion,

It should be noted that the secondary particle includes a great number of the primary particles, as described above. Further, since the primary particle is a single crystal, an oriented ratio of the primary particle does not matter. Accordingly, from the viewpoint that the oriented state of a great number of the primary particles in the secondary particle is considered as an oriented state of the (003) plane as the secondary particle as a whole, the oriented ratio of the (003) plane in the secondary particle can be said to be an “oriented ratio of the (003) planes of the primary particles in the secondary particle.”

For example, the oriented ratio of the (003) plane can be obtained by determining an orientation of the (003) plane of each of the primary particles in the secondary particle with respect to a plate surface or a cross-section (processed by a cross-section polisher or a focused ion beam, etc.) of the secondary particle using an Electron Backscatter Diffraction (EBSD) or a Transmission Electron Microscope (TEM), and by calculating a ratio of the number of the primary particles having the substantial same orientation (within ±10 degree) to the number of all of the primary particles.

The “aspect ratio” means a ratio of a diameter (longitudinal axis size) along a longitudinal axis of a particle to a diameter (short axis size) along a short axis. As the aspect ratio becomes closer to 1, it can be said that the particle has a shape more similar to a sphere.

The “voidage” means volume ratio of the voids (or pores: including opened pores and closed pores) in the cathode active material of the present invention. The “voidage” may be referred to as a “porosity.” For example, the “voidage” can be obtained from a SEM photo of the cross section of the secondary particle. The “opened pore” is a pore which communicates with the exterior (outside) among the pores. The “closed pore” is a pore which does not communicate with the exterior (outside) among the pores.

The “ratio of open pore” means an area ratio of the opened pores to all of the pores in the secondary particle. That is, the ratio of open pore is equal to (area of the opened pore portion)/(area of opened pore potion+area of closed pore portion). Since the opened pore communicates with the exterior, a resin can be poured into the opened pore. Since the closed pore does not communicate with the exterior, a resin can not be poured into the closed pore. In view of the above, the ratio of open pore can be obtained by:

performing resin embedding by pouring the resin into the voids (i.e., into the opened pores) while sufficiently eliminating air present in the opened pores using a vacuum impregnation equipment;

obtaining an area of the opened pores and an area of the closed pores by regarding the portion which has been impregnated with (filled with) the resin among the voids as the opened pores, and regarding the portion which has not been impregnated with (filled with) the resin among the voids as the closed pores, using an image processing of a SEM photo of the cross section of the secondary particle; and

calculating a value of (area of the opened pore portion)/(area of opened pore potion+area of closed pore portion).

The “mean pore size of opened pore” is an average of a diameter of the opened pore in the secondary particles. Typically, the “diameter” is a diameter of a sphere, when the opened pore is assumed to be the sphere having the same volume or the same cross-sectional area as the opened pore. It should be noted that the mean pore size is preferably calculated based on the volume. The “mean pore size of opened pore” can be obtained using a well known method such as the image processing of the SEM photo of the cross section of the secondary particle, and a mercury intrusion technique.

That is, the inventors of the present invention have found that the cell characteristics can be greatly improved by the followings, and have made the present invention, as a result of their effort.

uniaxially orientating the (003) plane in the secondary particle of the cathode active material having a layered rock salt structure (providing a large number of the single-crystalline primary particles that constitutes the secondary particle in such a manner that their (003) planes are parallel to each other to a maximum extent in the secondary particle: specifically, having the oriented ratio of the (003) plane of the primary particle in the secondary particle equal to or larger than 60% (preferably, 75% or more)).

setting the mean particle size, the aspect ratio, the voidage, the mean pore size of opened pore, the ratio of opened pore, and the value obtained through dividing the mean particle size of the primary particle by the mean pore size of the opened pore, within the above described range.

In the cathode active material of the present invention having the above features, a large number of the primary particles are present in the vicinity of the pores in the secondary particle, and the primary particles adjacent to each other have the substantially same directions of the electron conduction and of the lithium ion diffusion (especially, the direction of the electron conduction). This can secure a path for the electron conduction and a path for the lithium ion diffusion (especially, path for the electron conduction) in the secondary particle. Accordingly, the cell characteristics can be greatly improved by the present invention compared to the prior art.

It should be noted that, as described above, when the value “mean particle size of the primary particle/mean pore size of the opened pore” is equal to or larger than 0.1 and equal to or smaller than 5, the lithium ion conduction and the electron conduction in the secondary particle can be maximized.

In contrast, when the value “mean particle size of the primary particle/mean pore size of the opened pore” is smaller than 0.1, the number of the primary particles present in the vicinity of the pores becomes excessively large, and thus, the grain boundary resistivity becomes too large, so that the output characteristic and the rate characteristic deteriorate.

On the other hand, when the value “mean particle size of the primary particle/mean pore size of the opened pore” is larger than 5, the number of contact points between the primary particles existing in the vicinity of the pores becomes small, the lithium ion diffusion path and the electron conduction path (especially, electron conduction path) can not be secured, and thus, the output characteristic deteriorates. Especially, because the lithium ion diffusion path and the electron conduction path more frequently cross the (003) plane when an orientation of the secondary particle is high (the electron conduction to cross the (003) plane and the lithium ion diffusion to cross the (003) plane are hard to occur), the output characteristic greatly deteriorates.

### BRIEF DESCRIPTION OF DRAWINGS

FIG. 1 is a sectional view of a schematic configuration of a lithium secondary battery to which an embodiment of the present invention is applied.

FIG. 2 is an enlarged sectional view of a positive electrode plate shown in FIG. 1.

FIG. 3 is a schematic enlarged view of a cathode active material particle according to the present embodiment shown in FIG. 2.

FIG. 4 is a photo taken by an electron scanning microscope of the cathode active material particle according to the present embodiment shown in FIG. 3.

FIG. 5 is a partially enlarged view showing lithium ion diffusion in the cathode active material particle according to the present embodiment shown in FIG. 3, in contrast with a conventional cathode active material.

FIG. 6 schematically shows one of examples of a manufacturing method for the cathode active material particle according to the present embodiment shown in FIG. 2.

FIG. 7 is a view showing one modified example of the cathode active material particle shown in FIG. 3.

### DESCRIPTION OF EMBODIMENTS

Preferred embodiments of the present invention will next be described using examples and comparative examples. The following description of the embodiments is nothing more than the specific description of mere example embodiments of the present invention to the possible extent in order to fulfill description requirements (descriptive requirement and enabling requirement) of specifications required by law.

Accordingly, as will be described later, naturally, the present invention is not limited to the specific configurations of embodiments and examples to be described below. Modifications that can be made to the embodiments and examples are collectively described herein at the end, since insertion thereof into the description of the embodiments would disturb understanding of consistent description of the embodiments.

### 1. CONFIGURATION OF LITHIUM SECONDARY BATTERY

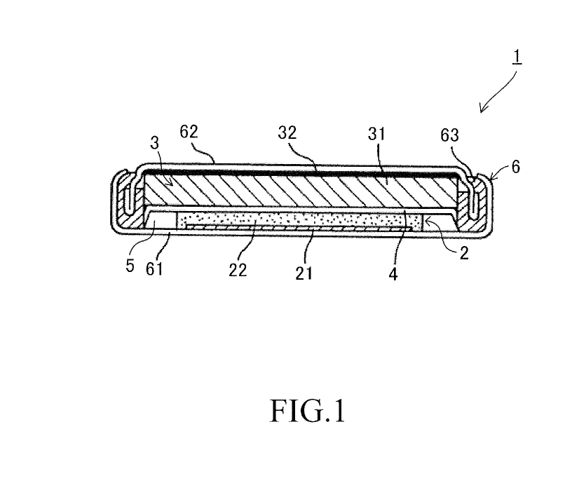

FIG. 1 is a sectional view of the schematic configuration of a lithium secondary battery 1 to which an embodiment according to the present invention is applied. Referring to FIG. 1, the lithium secondary battery 1 is a so-called liquid-type coin cell, and comprises a positive electrode plate 2, a negative electrode plate 3, a separator 4, an electrolytic solution 5, and a cell casing 6.

The positive electrode plate 2 is formed by laminating (layering) a cathode collector 21 and a cathode active material layer 22. Similarly, the negative electrode plate 3 is formed by laminating (layering) an anode cathode active material layer 31 and an anode collector 32.

The lithium secondary battery 1 is formed by laminating, on the cathode collector 21, the cathode active material layer 22, the separator 4, the anode active material layer 31, and the anode collector 32, in this order, and by liquid-tightly encapsulating the laminated body and the electrolytic solution 5 containing lithium compound as an electrolyte in the cell casing 6 (which includes a cathode side casing 61, an anode side casing 62, an insulation gasket 63).

The parts other than the cathode active material layer 22 of the lithium secondary battery 1 can be made of conventionally well known materials. For example, as the anode active material forming the anode active material layer 31, the following materials can be used: amorphous carbonaceous material such as soft carbon, and hard carbon; high graphitization carbon material such as artificial graphite, and natural graphite; acetylene black; carbon nanotube; carbon nano-fiber; or the like. Also, as the anode active material forming the anode active material layer 31, the following materials can be used: metallic lithium, or a lithium-occluding material such as an alloy which contains silicon, tin, indium, or the like; an oxide of silicon, tin, or the like which can perform charge and discharge at low electric potential near that at which lithium does; a nitride of lithium and cobalt such as Li_{2.6}Co_{0.4}N. Further, as another oxide, Li₄Ti₅O₁₂, TiO₂, Nb₂O₅, MoO₂, or the like can be used as the anode active material. Among those materials, the high graphitization carbon material having a large lithium capacity is preferably used. The negative electrode plate 3 is formed by coating the material for the anode prepared using those anode active materials on the anode collector 32 made of metallic foil or the like.

As an organic solvent used for the non-aqueous electrolytic solution 5, carbonate ester electrolytic solution such as ethylene carbonate (EC), diethyl carbonate (DEC), dimethyl carbonate (DMC), propylene carbonate (PC); noncomposite electrolytic solution such as γ-butyrolactone, tetrahydrofuran, acetonitrile; or composite electrolytic solution of those; are preferably used.

As the electrolyte contained in the electrolytic solution 5, lithium complex fluorine compound such as lithium hexafluorophosphate (LiPF₆), and lithium borofluoride (LiBF₄); lithium halide such as lithium perchlorate (LiClO₄); or the like can be used. Typically, the electrolytic solution 5 is prepared by dissolving one or more of those electrolyte into the above described organic solvent. Among those, LiPF₆ is preferably used since it is hard to be oxidation decomposed, and it provides high conductivity non-aqueous electrolytic solution.

Since the parts other than the cathode active material layer 22 of the lithium secondary battery 1 is well known, the detailed descriptions for those parts other than the above descriptions are omitted in the present specification.

### 2. CONFIGURATIONS OF CATHODE ACTIVE MATERIAL LAYER AND CATHODE ACTIVE MATERIAL PARTICLE

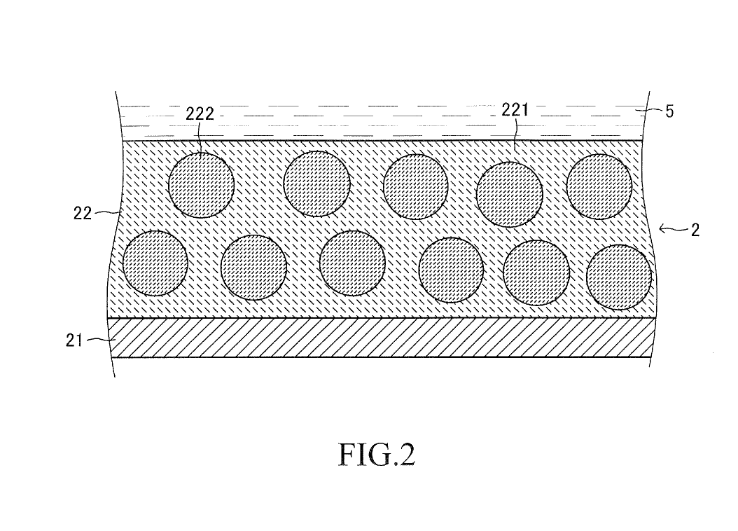

FIG. 2 is an enlarged sectional view of the positive electrode plate 2 shown in FIG. 1. Referring to FIG. 2, the cathode active material 22 comprises a binder 221, cathode active material particles 222 and conductivity agents (e.g., carbon, or the like), wherein the cathode active material particles 222 and the conductivity agents are uniformly-dispersed in the binder 221. The cathode active material 22 is joined to the cathode collector 21. That is, the positive electrode plate 2 is formed by preparing a material for the cathode through mixing the cathode active material particles 222, polyvinylidene fluoride (PVDF) etc., serving as the binder 221, and acetylene black etc., serving as the conductivity agent in an predetermined ratio, and by coating the material for the cathode on a surface of the cathode collector 21 made of metallic foil or the like.

The cathode active material particle 222 according to the present embodiment is formed so as to be a fine particle whose mean particle size is equal to or larger than 1 μm and equal to or smaller than 100 μm, have a substantial spherical shape or a substantial spheroid shape, specifically, its aspect ratio is equal to or larger than 1.0 and smaller than 2 (preferably, 1.1-1.5).

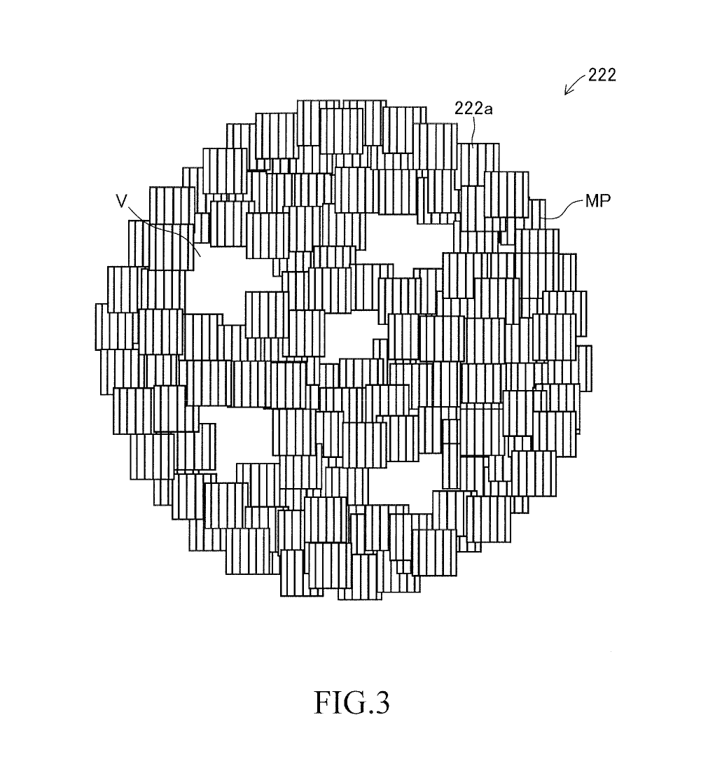

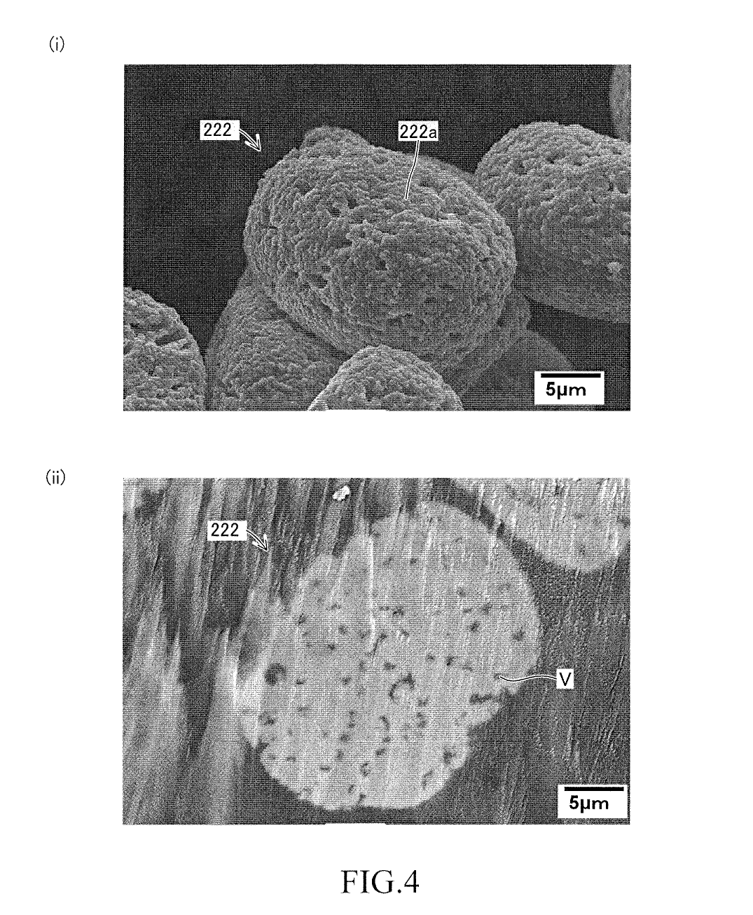

FIG. 3 is an enlarged view schematically showing the cathode active material particle 222 (an example 1 described later) according to the present embodiment shown in FIG. 2. FIG. 4 shows SEM images of the cathode active material particle 222 according to the present embodiment shown in FIG. 3. In FIG. 4, (i) is a SEM image of a surface of the particle, and (ii) is a SEM image of a section of the particle.

As shown in FIG. 3, the cathode active material particle 222 is a secondary particle, which is formed in such a manner that a plurality of single-crystalline primary particles 222a formed of lithium composite oxide having a layered rock salt structure congregate. The single-crystalline primary particles 222a has a mean particle size which is equal to or larger than 0.01 μm and equal to or smaller than 5 μm, and is formed in such a manner that the (003) planes denoted by “MP” in the figure are in-plane oriented (that is, in such a manner that the (003) plane intersects with a plate surface of the single-crystalline primary particle 222a). It is needless to say that all of the (003) planes are parallel to each other in a single single-crystalline primary particle 222a.

The cathode active material particle 222 according to the present embodiment has an excellent uniaxially-orientation of the (003) plane. That is, in the cathode active material particle 222, a plurality of the single-crystalline primary particles 222a forming the cathode active material particle 222 are arranged/provided in such a manner that orientations of the (003) planes of those particles coincides with each other (the (003) planes of those particles are parallel to each other to a maximum extent). Specifically, the cathode active material particle 222 is formed in such a manner that the oriented ratio of the (003) plane is equal to or larger than 60% (preferably, 75% or more) (in such a manner that a ratio of the number of the single-crystalline primary particles 222a whose (003) plane orientation is the same as each other to the total number of a plurality of the single-crystalline primary particles 222a included in the cathode active material particle is equal to or larger than 60% (preferably, 75% or more)).

Further, the cathode active material particle 222 has a large number of pores V. That is, in the cathode active material particle 222, the voidage (porosity) is equal to or larger than 3% and equal to or smaller than 30%, and the mean pore size of the opened pore is equal to or larger than 0.1 μm and equal to or smaller than 5 μm. Furthermore, in the cathode active material particle 222, a value obtained through dividing a mean particle size of the single-crystalline primary particle 222a by the mean pore size of the opened pore is equal to or larger than 0.1 and equal to or smaller than 5. The value obtained is preferably equal to or larger than 0.5 and equal to or smaller than 5, and more preferably equal to or larger than 1 and equal to or smaller than 3.

### 3. FUNCTION AND EFFECT OF THE CATHODE ACTIVE MATERIAL PARTICLE ACCORDING TO THE PRESENT EMBODIMENT

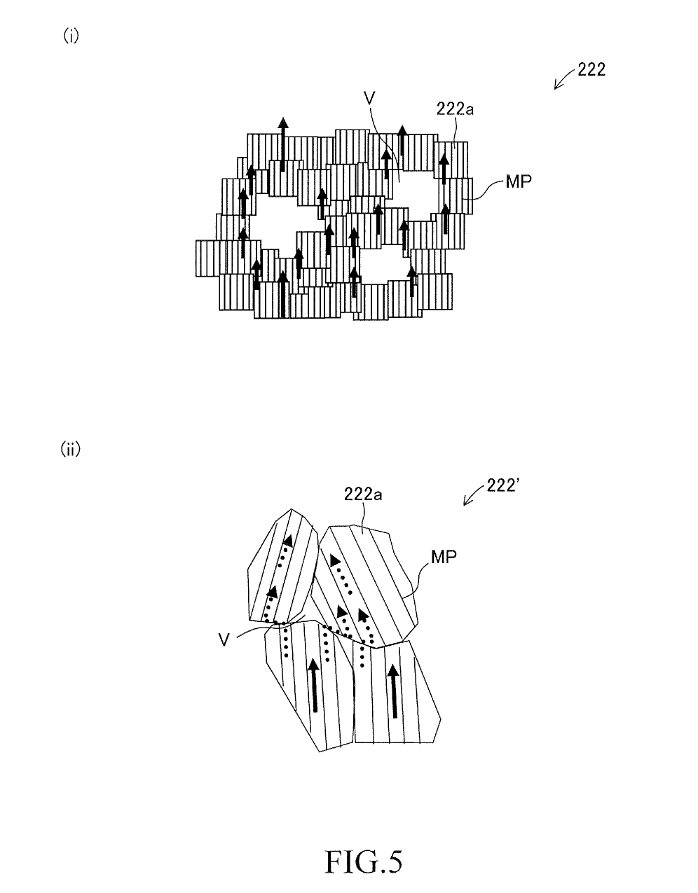

FIG. 5 is a partially enlarged view schematically showing lithium ion diffusion in the cathode active material particle 222 according to the present embodiment shown in FIG. 3, in contrast with a conventional cathode active material. It should be noted that (i) of FIG. 5 is a partially enlarged view of the cathode active material particle 222 according to the present embodiment, and (ii) of FIG. 5 is a partially enlarged view of the conventional cathode active material particle 222′. Arrows in the figure indicate electron conduction.

In the cathode active material particle 222 according to the present embodiment, the single-crystalline primary particles 222a are included in such a manner that the (003) plane is uniaxially oriented (specifically, in such a manner that the oriented ratio of the (003) plane is equal to or larger than 60% (preferably, 75% or more)), the voidage (porosity) is equal to or larger than 3% and equal to or smaller than 30%, and the mean pore size of the opened pore is equal to or larger than 0.1 μm and equal to or smaller than 5 μm, and the value “the mean particle size of the primary particle/the mean pore size of the opened pore” is equal to or larger than 0.1 and equal to or smaller than 5.

In the thus configured cathode active material particle 222 according to the present embodiment, a large number of the single-crystalline primary particles 222a are present in the vicinity of the pores V (in such a manner that the grain boundary resistivity does not become excessively large), and a plurality of the single-crystalline primary particle 222a adjacent to each other have the substantially same directions of the electron conduction and of the lithium ion diffusion. This can secure a path for the electron conduction and a path for the lithium ion diffusion. Accordingly, a resistance for the electron conduction between the single-crystalline primary particles 222a and a resistance for the lithium ion diffusion between the single-crystalline primary particles 222a are decreased, and thus, the electron conduction and the lithium ion diffusion are improved. Consequently, the cathode active material particle 222 according to the present embodiment can greatly improve the charge and discharge characteristics (especially, the rate characteristic and the output characteristic) of the lithium secondary battery 1.

In contrast, in the conventional cathode active material particle 222′ shown in (ii) of FIG. 5 (for example, refer to Japanese patent No. 4,740,409, and Japanese patent No. 4,740,415), the number of the single-crystalline primary particles 222a in the vicinity of the pores V is small, and the path for the electron conduction and the path for the lithium ion diffusion become discontinuous at the grain boundaries (refer to the arrows shown by the dotted line in the figure). Accordingly, such a configuration can not preferably secure the path for the electron conduction and the path for the lithium ion diffusion, and therefore, the excellent electron conduction and the excellent lithium ion diffusion can not be realized.

The function and effect of the configuration of the cathode active material particle 222 according to the present embodiment will next be described in more detail. As described above, in the cathode active material particle 222 according to the present embodiment, the (003) planes are substantially uniaxially-oriented. Specifically, since the oriented ratio of the (003) plane is equal to or larger than 60% (preferably, 75% or more), the resistance for the lithium ion diffusion and the resistance for the electron conduction, between the single-crystalline primary particles 222a (i.e., at the grain boundaries), are decreased, and thus, the performance of the electron conduction and the performance of the lithium ion diffusion are improved. This can greatly improve the charge and discharge characteristics (especially, the rate characteristic and the output characteristic) of the lithium secondary battery 1.

That is, as shown in (i) of FIG. 5, the (003) planes (refer to “MP” in the figure) of the single-crystalline primary particles 222a forming the cathode active material particle 222 including the pores V is oriented to a specific direction, and therefore, the grain boundary resistivity is reduced. By means of this decrease in the grain boundary resistivity as well as the pores V containing the electrolytic solution and the conductivity agent, the lithium ion conduction and the electron conduction in the cathode active material particle 222 including the pores V can be maximized.

In contrast, as shown in (ii) of FIG. 5, the path for the lithium ion conduction and the path for the electron conduction are narrow, even when the conventional cathode active material particle 222′ includes the pores V which the electrolytic solution permeates. This deteriorates the lithium ion conduction and the electron conduction. It should be noted that the narrowest portion (neck portion) of the path for the lithium ion conduction and the electron conduction is likely to be the grain boundary. Accordingly, when the grain boundary resistivity is high, the lithium ion conduction and the electron conduction greatly deteriorate.

Especially, the electronic conduction can not occur through the pore V, and thus, occurs through the grain boundary between the single-crystalline primary particles 222a adjacent to each other. From this point of view, the cathode active material particle 222 according to the present embodiment can secure the excellent electronic conductivity. In contrast, the above described cathode active material particle 222′ (refer to Japanese patent No. 4,740,409, and Japanese patent No. 4,740,415) is hard to secure the excellent electronic conductivity.

Further, micro-cracks which typically occur between the single-crystalline primary particles 222a (i.e., at grain boundary) due to volume expansion and volume contraction associated with a repetition of charge and discharge are likely to take place in parallel with the (003) plane which is a lithium ion diffusion plane and an electron conduction plane (i.e., in a direction such that the cracks do not increase diffusion resistance, and do not cause adverse effects on the electron conductivity). Accordingly, the deterioration of the charge and discharge characteristics (especially, the rate characteristic) due to a repetition of charge and discharge cycle can be avoided.

It should be noted that the oriented ratio of the (003) plane is preferably equal to or larger than 70%, and more preferably, equal to or larger than 90%. It can be said that, as the oriented ratio becomes higher, it is more likely that the in-plane directions of the (003) planes that are the directions in which the lithium ion diffusion and the electron conduction are preferably performed become parallel to each other in a large number of the single-crystalline primary particles 222a that are included in the cathode active material particle 222. Accordingly, as the oriented ratio becomes higher, a diffusion distance of the lithium ion and an electron travel distance can be shortened, and as described above, the diffusion resistance of lithium ion and the electronic resistance are decreased. Consequently, the charge and discharge characteristics of the lithium secondary battery 1 is greatly improved. Therefore, for example, when the cathode active material particle 222 is used as the material for the cathode of the liquid-type lithium secondary battery 1, and even when the mean particle size of the cathode active material particle 222 are increased for the purpose of improving its durability, its capacity, and its safety, the high rate characteristic can be maintained by increasing the oriented ratio.

Further, the mean particle size of the single-crystalline primary particle 222a is equal to or larger than 0.01 μm and equal to or smaller than 5 μm, preferably equal to or larger than 0.01 μm and equal to or smaller than 3 μm, more preferably equal to or larger than 0.01 μm and equal to or smaller than 1.5 μm. Maintaining the mean particle size of the single-crystalline primary particle 222a within the above described range can secure the crystallinity of the single-crystalline primary particle 222a.

If the mean particle size of the single-crystalline primary particle 222a is smaller than 0.1 μm, there may be a case in which the crystallinity of the single-crystalline primary particle 222a deteriorates, and thus, the output characteristic and the rate characteristic of the lithium secondary battery 1 deteriorate. In contrast, in the cathode active material particle 222 according to the present embodiment, even when the mean particle size of the single-crystalline primary particle 222a is from 0.1 to 0.01 μm, the case does not occur in which the output characteristic and the rate characteristic deteriorate.

Further, having the mean particle size of the single-crystalline primary particle 222a within the above described range can reduce an occurrence of a crack in the cathode active material particle 222 serving as the secondary particle due to the volume expansion and the volume contraction of the single-crystalline primary particle 222a during charging and discharging, to a maximum extent. In contrast, when the mean particle size of the single-crystalline primary particle 222a is larger than 5 μm, stress caused by the volume expansion and the volume contraction of the single-crystalline primary particle 222a during charging and discharging may generate the crack(s) in the cathode active material particle 222 serving as the secondary particle.

The mean particle size of the cathode active material particle 222 serving as the secondary particle is equal to or larger than 1 μm and equal to or smaller than 100 μm, preferably equal to or larger than 2 μm and equal to or smaller than 70 μm, more preferably equal to or larger than 3 μm and equal to or smaller than 50 μm. Having the mean particle size of the cathode active material particle 222 within the above described range can improve a degree of filling of the cathode active material in the cathode active material particle 222 (filling rate is increased). In addition, a flat surface of the electrode can be formed while maintaining the output characteristic and the rate characteristic of the lithium secondary battery 1.

On the other hand, if the mean particle size of the cathode active material particle 222 is smaller than 1 μm, there may be a case in which the filling rate is decreased. Further, if the mean particle size of the cathode active material particle 222 is larger than 100 μm, there may be a case in which the output characteristic and the rate characteristic of the lithium secondary battery 1 deteriorate.

A distribution of the mean particle size of the cathode active material particle 222 may be sharp, broad, or has a plurality of peaks. For example, when the distribution of the mean particle size of the cathode active material particle 222 is not sharp, a filling density of the cathode active material in the cathode active material particle layer 22 can be increased, or an adhesion force between the cathode active material particle layer 22 and the cathode collector 21 can be enhanced. This can further improve the charge and discharge characteristics.

The aspect ratio of the cathode active material particle 222 is equal to or larger than 1.0 and smaller than 2.0, and preferably equal to or larger than 1.1 and smaller than 1.5. Having the aspect ratio of the cathode active material particle 222 within the above described range can form an appropriate gap between the cathode active material particles 222 which enables to secure a path which allows a diffusion of the lithium ion contained in the electrolytic solution 5 poured into the cathode active material layer 22, even when the filling density of the cathode active material in the cathode active material layer 22 is increased. This can further improve the output characteristic and the rate characteristic of the lithium secondary battery 1.

On the other hand, when the aspect ratio of the cathode active material particle 222 is larger than 2.0, the cathode active material particles 222 are apt to be filled in such a manner that the plate surface of the cathode collector 21 and the longitudinal axis direction of the particle are parallel to each other when forming the cathode active material layer 22. This lengthens a diffusion distance of the lithium ion contained in the electrolytic solution 5 poured into the cathode active material layer 22 in the thickness direction of the cathode active material layer 22. This may cause the deterioration in the output characteristic and the rate characteristic of the lithium secondary battery 1.

The aspect ratio of the single-crystalline primary particle 222a is preferably equal to or larger than 1.0 and smaller than 2.0, and more preferably equal to or larger than 1.1 and smaller than 1.5. Having the aspect ratio of the single-crystalline primary particle 222a within the above described range can secure the lithium ion conductivity and the electron conductivity preferably.

The voidage (volume ratio of the pore V) in the cathode active material particle 222 is equal to or larger than 3% and is equal to or smaller than 30%. Having the voidage within this range can improve the charge and discharge characteristics without damaging its capacity. A more preferable range of the voidage is equal to or larger than 4% and is equal to or smaller than 20%.

When the ratio of opened pore is equal to or larger than 70%, the electrolytic solution can be more sufficiently poured into the inside of the cathode active material, the charge and discharge characteristics are improved, since the lithium ion diffusion into the inside of the particle is expedited, and a contact area between the electrolytic solution and the cathode active material is increased. The ratio of opened pore is preferably equal to or larger than 80%, and more preferably equal to or larger than 90%.

The mean pore size of opened pore in the cathode active material particle 222 (average of diameter of the opened pores among pores V in the cathode active material particle 222) is equal to or larger than 0.1 μm and equal to or smaller than 5 μm. When the mean pore size of opened pore is larger than 5 μm, relatively large pores V are formed. When such large pores V are present, an amount of the cathode active material which can contribute to the charge and discharge per unit volume decreases. A stress concentration can easily occur at local position of each of the large pores V, and an effect of uniformly releasing the stress in its inside can not be realized. In contrast, when the mean pore size of opened pore is smaller than 0.1 μm, it becomes difficult to hold the conductivity agent and the electrolytic solution in its inside, and an effect of releasing the stress by means of the pores V becomes insufficient. Thus, there may be a case in which an effect of improving the charge and discharge characteristics with maintaining a high capacity can not be realized. A preferable range of the mean pore size of opened pore is equal to or larger than 0.5 μm and equal to or smaller than 5 μm, and more preferable range of the mean pore size of opened pore is equal to or larger than 1 μm and equal to or smaller than 3 μm.

It should be noted that, in order to realize the above described desirable voidage and the mean pore size, a pore-forming material (agent for forming voidage) as an additive agent can be added to the raw material. As the pore-forming material, a particulate material or a fibrous material that are dissolved (evaporated or carbonated) during a calcination process can be preferably used. Specifically, a particulate material or a fibrous material, made of an organic synthetic resin such as theobromine, nylon, graphite, phenol resin, polymethylmethacrylate, polyethylene, polyethylene terephthalate, and foamable resin, can be preferably used. Needless to say, it is possible to realize the above described desirable voidage and the mean pore size, without using the pore-forming material, by adjusting a type and a particle size of the raw material, a firing temperature during the calcination process (heat treatment process), or the like.

### 4. OUTLINE OF MANUFACTURING METHOD

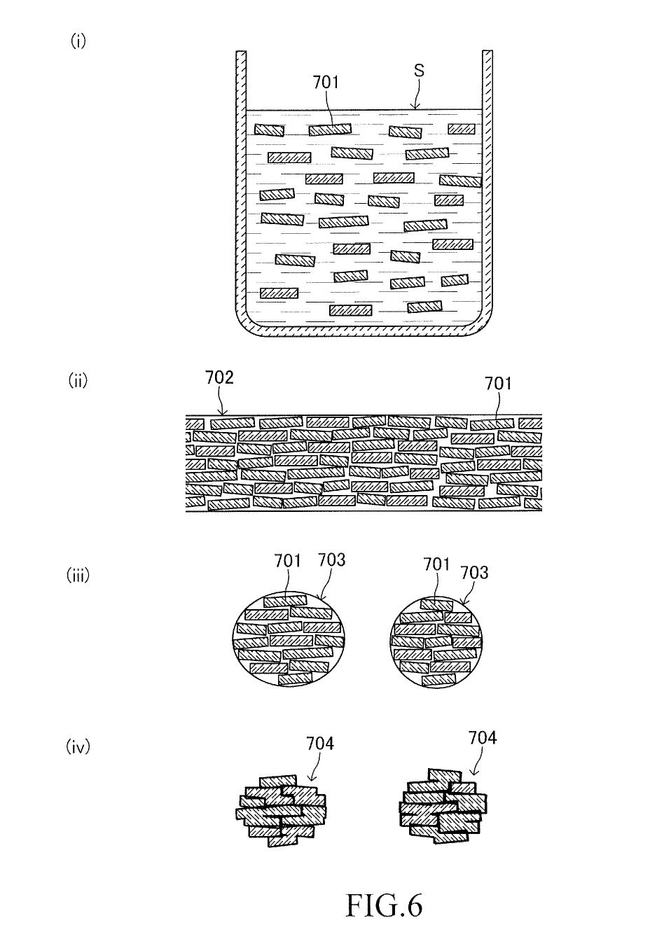

The cathode active material particle 222 can be manufactured by a manufacturing method as described below, for example. FIG. 6 schematically shows an example of such manufacturing methods.

### (1) Preparation of Particles Serving as Raw Material

Particles serving as the raw material can be a mixture formed by appropriately mixing particles of compound of Li, Co, Ni, Mn, Al, or the like in such a manner that a composition of the cathode active material becomes LiMO₂. Specifically, for example, mixed particles of compounds of Co, Ni, Mn, Al, or the like (but which does not contain lithium compound) (mixed particles having a composition such as (Co, Ni, Mn)Oₓ, (Co, Ni, Al)Oₓ, (Co, Ni, Mn)OHₓ, (Co, Ni, Al)OHₓ) can be used. The cathode active material particle 222 having a predetermined composition is obtained by forming the mixed particles, and thereafter, by reacting the thus obtained compact with lithium compound. Those particles may be the particles themselves, or complex compounds synthesized according to the coprecipitation method.

For the purpose of increasing the oriented ratio, the hydroxide having a composition of (Co, Ni, Mn)OHₓ, (Co, Ni, Al)OHₓ, or the like is preferably used as the raw material particle. Such a hydroxide cab be a flat shape primary particle having the (001) plane on a flat surface, and thus, it is easy to orient the primary particle by a forming process described later. The (001) plane is a plane in which orientation is maintained (taken over) as the (003) plane of the cathode active material having a predetermined composition by a reaction with the lithium compound. Accordingly, it is easy to orient the (003) plane in the cathode active material particle 222 by using such a plate-like raw material particle.

It should be noted that an extra amount of lithium compound may be mixed into the raw material particles in such a manner that lithium becomes in excess of 0.5-40 mol %, in view of a facilitation of a grain growth and/or a volatilization of lithium during firing. Further, for the purpose of the facilitation of the grain growth, low-melting point oxide (bismuth oxide, or the like), low-melting-point glass (borosilicate glass, or the like), lithium fluoride, lithium chloride, or the like may be added in (by) 0.01-30% by mass to the raw material particles. In addition, as described above, the pore-forming material (void-forming material) may arbitrarily be added in order to realize the desirable “voidage” and “mean pore size of opened pore.”

A part of the raw material particles can be replaced by another raw material. For example, a part of Mn of (Co, Ni, Mn)OH), can be replaced by MnCO₃. This can realize a sufficient orientation, and can change the pore size and the voidage.

### (2) Shape Forming of the Raw Material Particles

The prepared raw material particles are formed into a self standing sheet-like compact with a thickness of 100 μm or less. Here, the “self standing compact” means a compact which can keep its compact shape by itself. It should be noted that the “self standing compact” may include a sheet-like compact which can not keep its compact shape by itself, but which is formed into a sheet-like shape by being adhered to or being formed as a film on a certain substrate, and thereafter, is released (delaminated) from the substrate before or after being fired. Specifically, a sheet formed by an extrusion is the “self standing compact” immediately after being formed. In contrast, a film formed by applying slurry can not be treated/handled by itself, however, thereafter becomes the “self standing compact” after being dried and released from the substrate. Further, an expression of the “sheet-like” includes plate-kike, flake-like, or scale-like, etc.”

There is no limit on the forming method, as long as the raw material particles are filled into the compact in such a manner that crystal orientations coincide with each other in the compact. For example, a compact (self standing sheet-like compact) can be obtained in which the raw material particles are filled into the compact in such a manner that crystal orientations coincide with each other in the compact, by forming a film using a slurry containing the raw material particles according to doctor blade method. Specifically, when the doctor blade method is used, firstly, the slurry S (refer to (i) shown in FIG. 6) containing the raw material particles 701 are applied to a flexible substrate (e.g., a plate made of organic polymer, such as a PET film, and the like), and the applied slurry S is dried and solidified to be a dried film. Subsequently, the dried film is released from the above described substrate so as to obtain a compact 702 in which the raw material particles 701 are oriented (in which the raw material particles are filled in such a manner that their crystal orientations coincide with each other) (refer to (ii) shown in FIG. 6).

Alternatively, using a drum dryer, a slurry containing the raw material particles are applied to a heated drum so as to be dried, and thereafter, the dried slurry is scraped with a scraper from the drum, so as to obtain the above described compact 702. Furthermore, using a disc dryer, a slurry containing the raw material particles are applied to a heated circular disc so as to be dried, and thereafter, the dried slurry is scraped with a scraper from the disc, so as to obtain the above described compact 702. Alternatively, an extrusion may be performed using a green body containing the raw material particles so as to obtain the above described compact 702.

When preparing the slurry or the green body before being formed, the raw material particles are dispersed in an appropriate disperse media, and then, a binder, a plasticizer, or the like may be added. A type or an amount of the additives such as the binder, and the like, are appropriately determined in such a manner that the filling density and the degree of orientation of the raw material particles when being formed are controlled so as to become the desirable states, or shapes of crushed products during the crushing process described later are controlled so as to become the desirable state. Specifically, for example, when a flexibility of the compact before being crushed is high, an aspect ratio of the crushed product when being crushed is apt to become large. Thus, a type and/or an amount of the binder, the plasticizer, or the like are appropriately adjusted in such a manner that the flexibility of the compact before being crushed does not become excessively high. Accordingly, for example, in order to control the flexibility of the compact before being crushed, the compact may be dried at a temperature in the range from 200° C. to 500° C. which causes a denaturation or a decomposition of the binder.

When the slurry containing the raw material particles is used, it is preferable that a viscosity be adjusted in the range from 0.5 to 5 Pa·s, or that defoaming be performed under reduced pressure. Further, when another compound is made present in the pores V, it is preferable that a slurry containing the raw material particles and the compound be prepared.

The thickness of the compact 702 is preferably equal to or smaller than 120 μm, and more preferably equal to or smaller than 100 μm. In addition, the thickness of the compact 702 is preferably equal to or larger than 1 μm. When the thickness of the compact 702 is equal to or larger than 1 μm, it is easy to manufacture the self standing sheet-like compact. It should be noted that the thickness of the compact 702 is appropriately determined in accordance with the application of the particles, since the thickness of the compact 702 is a direct factor to determine the mean particle size of the cathode active material particle 222.

### (3) Crushing of the Compact

The obtained compact 702 is crushed/ground in such a manner that the cathode active material particle 222 has a desirable aspect ratio. Examples of crushing method are a method in which the compact is pressed against a mesh with a paddle; a method for crushing using a cracking machine having a weak cracking force such as a pin mill, and the like; a method in which chips of the sheet are made collide with each other in an air current (specifically, throw the compact 702 into an air classifier); a method for cracking the compact with a mixer in which a moving vane rotates at high speed; using a rotational flow type jet mill; pot crushing; barrel polishing; and so on. Alternatively, crushing may be made by taking out an initial compact which is sheet-like and adhered to a drum from the drum while providing a desirable size to powders: example of such includes providing concavities and convexities on the drum, drying a surface of the compact by applying a heat from the outside of the compact, or the like.

Further, a process for spheroidizing the crushed product may be performed. By this process, the cathode active material particle 222 which is finally obtained has a substantial spherical shape or a substantial spheroid shape. Providing the cathode active material particle 222 with the substantial spherical shape or the substantial spheroid shape increases an exposure of the surface for intercalation and deintercalation of lithium ions and an exposure of the electron conduction plane, and increases the filling rate of the cathode active material particle 222 in the cathode active material layer 22. Accordingly, the cell characteristics are improved.

The process for spheroidizing may be the following, for example: a method to round off the corners by having the crushed products particles collide with each other in an air current (air classifying, hybridization, or the like); a method to round off the corners by having the crushed products particles collide with each other in a case (method using a hybrid mixer in which the case rotating and revolving at high speed, or using a mixer in which a vane rotates at high speed, barrel polishing, or the like); mechanochemical processing; a method to melt a surface of the crushed product particle using hot air. The spheroidizing and the crushing may be carried out separately, but, may be performed simultaneously. That is, for example, using the air classifier can carry out both the spheroidizing and the crushing.

It should be noted that the compact may be degreased beforehand, or may be heat treated (fired or calcinated), in order to facilitate the crushing and the spheroidizing. For example, as described above, in order to control the flexibility of the compact before being crushed, the compact may be dried at the relatively high temperature which causes the denaturation or the composition of the binder. Alternatively, when the raw material particle is plate-like (e.g., when the raw material particle is hydroxide), the compact before being crushed has an inner structure in which a large number of the plate-like raw material particles are aligned/arranged in parallel with the plate surface of the compact and agglutinated. Accordingly, the compact tends to have an anisotropic nature in strength, and thus, the aspect ratio of the crushed product is apt to be large when being crushed (that is, it becomes difficult to have the aspect ratio smaller than 2). Therefore, in this case, it is preferable that calcination be carried out before being crushed, or the crushing be performed after a firing/sintering process (lithium introducing process) described later.

The calcination before the compact is crushed can have the inner structure of the compact before being crushed and fired (before introducing lithium) be in a state in which the oxide having an isotropic shape is necking, and thus, it becomes easier to have the aspect ratio of the crushed products be smaller than 2. A temperature of the calcination is preferably in the range from 400 to 1100° C. When the calcination temperature is lower than 400° C., size of the crushed product becomes excessively small by the crushing, because the progress of the above described necking becomes insufficient, and thus, the compact after the calcination becomes brittle. In contrast, when the calcination temperature is higher than 1100° C., firing of the raw material progresses too far, and therefore, the reaction when introducing lithium progresses insufficiently. As a result, the lithium composite oxide having the desirable composition can not be synthesized. It is particularly preferable that the calcination before crushing be carried out for a composition which does not cause bad effect such as phase splitting due to the calcination, and the like (e.g., for series which include nickel but do not include manganese, such as nickel-cobalt series, nickel-cobalt-aluminium series, and nickel-aluminium series).

When the calcination is carried out, the pores can be controlled by changing a rate of temperature increase. The rate of temperature increase is preferably in the range from 10 to 400° C./h. When the rate of temperature increase is lower than 10° C./h, there may be a case in which the oriented ratio becomes low since an atomic arrangement of the raw material particle is disturbed when the pores are formed. In contrast, when the rate of temperature increase is higher than 400° C./h, the effect provided by the pore-forming agent can not be sufficiently acquired, and thus, the desired pore size and the desired voidage are hard to be obtained.

In a case in which the calcination is not carried out before being crushed, a state remains in which the raw material particles (plate-like raw material particles) 701 are excellently oriented in the precursor particle 703 for the cathode active material which is the obtained crushed product (refer to (iii) of FIG. 6). That is, the precursor particle 703 for the cathode active material is a raw particulate aggregate which contains a large number of the plate-like raw material particles 701, and is formed in such a manner that the plate-like raw material particles 701 are oriented substantially uniformly.

In contrast, in a case in which the calcination is carried out before being crushed, the state does not remain in which the raw material particles (plate-like raw material particles) are oriented in the precursor particle 704 for the cathode active material which is the obtained crushed product, since the necking described above (grain growth) progresses (refer to (iv) of FIG. 6). That is, the precursor particle 704 for the cathode active material has an inner structure which substantially corresponds to an inner structure of the precursor particle 703 for the cathode active material obtained after the particle 703 is heat treated. Accordingly, the precursor particle 704 for the cathode active material can be formed by obtaining the precursor particle 703 for the cathode active material by crushing without performing the calcination, and thereafter, calcining the precursor particle 703.

The products having an aspect ratio other than the desired aspect ratio (products which have a large aspect ratio because the products have not been sufficiently crushed) or the fine particles among products obtained by crushing or spheroidizing are reused.

Through the processes described above, the precursor particles 703 or 704 for the cathode active material, whose aspect ratio is equal to or larger than 1.0 and smaller than 2.0 (preferably, 1.1-1.5), and which have the predetermined inner structure, are formed, so that the cathode active material particles 222 have the desired aspect ratios and the desired orientation state of the (003) plane.

(4) Mixing with Lithium Compound

A pre-fired mixture is obtained by mixing the thus obtained precursor particles 703 or 704 for the cathode active material and the lithium compounds (lithium hydroxide, lithium carbonate, and the like). As a mixing method, dry mixing, wet mixing, or the like is used. It is preferable that the mean particle size of the lithium compound be 0.1-5 μm. When the mean particle size of the lithium compound is equal to or larger than 0.1 μm, the lithium compound is easily handled in view of hygroscopic nature. When the mean particle size of the lithium compound is equal to or smaller than 5 μm, the reaction with the crushed products is enhanced. It should be noted that an amount of lithium may be 0.5-40 mol % excess so as to enhance the reaction.

### (5) Firing (Sintering: Introduction of Lithium)

Lithium is introduced into the precursor particle 703 or 704 for the cathode active material by firing/sintering the above described pre-fired mixture according to an appropriate method, so that the cathode active material particle 222 is obtained. Specifically, for example, firing is carried out by putting a capsule containing the above described pre-fired mixture into a furnace. By the firing, synthesizing the cathode active material, sintering the particles, and growing grains are achieved. At this point in time, as described before, since the (001) planes are oriented in the compact (precursor particle 703 or 704 for the cathode active material), the crystal orientation is inherited, the cathode active material particle 222 having the predetermined composition is obtained in which the (003) planes are preferably uniaxially oriented.

A firing temperature is preferably within a range from 600° C. to 1100° C. When the firing temperature is within this range, the grain growth becomes sufficient so that the oriented ratio becomes high, and the desired composition is readily realized since the disaggregation of the cathode active material and the volatilization of lithium are depressed. The firing time (duration) is preferably 1 to 50 hours. When the firing time is within this range, the oriented ratio becomes high, and it can be avoided that an energy consumed for the firing increases excessively.

Further, for the purpose of enhancing a reaction between lithium and the precursor that have been mixed, during a temperature increase process, the temperature may be held at a temperature (e.g. 400 to 600° C.) lower than the firing temperature for 1 to 20 hours. Through the temperature holding process, lithium is melted, and thus the reaction is enhanced. It should be noted that the same effect can be achieved by adjusting the rate of temperature increase when the temperature is within a certain range (e.g. 400 to 600° C.) during the firing (lithium introduction) process.

The firing environment needs to be set appropriately in such a manner that the disaggregation does not progress during firing. In a case in which lithium volatilization progresses, it is preferable that the firing environment be set to lithium atmosphere by providing lithium carbonate, or the like in the same capsule. In a case in which release of oxygen, and further, reduction progress during firing, it is preferable that the firing be carried out at an atmosphere in which an oxygen partial pressure is high. It should be noted that, after firing, for the purpose of disgregating an adhesion or an aggregation between cathode active material particles 222, or the purpose of adjusting the mean particle size of the cathode active material particle 222, crushing or classifying may be performed at appropriate timings (the crushing and the classifying may be referred to as a “secondary crushing” and a “secondary classifying”, respectively, as they are performed after the above described crushing and classifying). Alternatively, the crushing process may be carried out after firing. That is, the crushing process (and the classifying process) may be carried out only after firing.

In addition, a post-heat-treatment may be carried out at a temperature ranging from 100° C. to 400° C. for the cathode active material obtained after firing or after crushing and classifying. The post-heat-treatment process can reform surface layers of the primary particles, and thus, the rate characteristic and the output characteristic are improved.

### 5. EXAMPLES

Hereinafter, examples (specific manufactured example) of the cathode active material particle 222 according to the present embodiment and the evaluation result will be described with comparative examples. It should be noted that, in the descriptions on the following examples and the comparative examples, “part” and “%” are based on weight, unless it is explicitly stated otherwise. Further, for the purpose of simplifying the descriptions, the cathode active material particle 222 is simply referred to as a “secondary particle”, and the mean particle size of the secondary particle is simply referred to as a “secondary particle size.” In addition, the single-crystalline primary particle 222a is simply referred to as a “primary particle”, and the mean particle size of the primary particle is simply referred to as a “primary particle size.”

Measuring methods of various physical property values, and evaluation methods of various characteristics are as follows.

[Secondary Particle Size (μm)]

A median size (D50) of the secondary particle is measured using water as a disperse media by a laser diffraction/scattering type grain size distribution measuring apparatus (model number “MT3000-II” manufactured by Nikkiso Co., Ltd). The measured median size is adopted as the secondary particle size.

[Primary Particle Size (μm)]

A SEM image are taken while selecting a magnification in such a manner that ten or more of the primary particles are within the visual field by a FE-SEM (field-emission-type scanning electron microscope: model name “JSM-7000F” manufactured by Japan Electron Optics Laboratory Co., Ltd.). Using the image, a diameter of a circumscribed circle for each of the ten primary particles is measured. An average of the thus obtained ten diameters is adopted as the primary particle size.

### [Aspect Ratio of Secondary Particle]

A SEM image are taken while selecting a magnification in such a manner that ten or more of the secondary particles are within the visual field by the above described FE-SEM. Using the SEM image, a longitudinal axis size and a short axis size of each of ten secondary particles are measured, and thereafter, each value is obtained by dividing the longitudinal axis size by the short axis size. An average of the thus obtained ten values is adopted as the aspect ratio of the secondary particle.

### [Aspect Ratio of Primary Particle]

A SEM image are taken while selecting a magnification in such a manner that ten or more of the primary particles are within the visual field by the FE-SEM. Using the SEM image, a longitudinal axis size and a short axis size of each of ten primary particles are measured, and thereafter, each value is obtained by dividing the longitudinal axis size by the short axis size. An average of the thus obtained ten values is adopted as the aspect ratio of the primary particle.

### [Voidage (%)]

The cathode active material particle is embedded with a resin, and is polished by a cross section polisher (CP) in such a manner that a polished sectional surface of the cathode active material particle can be observed. An section image is taken by a SEM (scanning electron microscope JSM-6390LA manufactured by Japan Electron Optics Laboratory Co., Ltd.). A value which is equal to (area of pore portion)/(area of pore portion+area of cathode material portion) is obtained by discriminating the pore portion from the cathode material portion using image processing of the obtained image. This operation is carried out for ten of the secondary particles. An average of the ten values is adopted as the voidage.

### [Ratio of Opened Pore (%)]

After embedding the resin into the pores (pouring operation of the resin) is performed, the ratio of opened pore is obtained by calculating a value equal to (area of the opened pore portion)/(area of opened pore potion+area of closed pore portion), while regarding the portion which has been impregnated with (filled with) the resin among the void portion as the opened pores, and regarding the portion which has not been impregnated with (filled with) the resin among the void portion as the closed pores, in the method of evaluating the voidage described above. This operation is carried out for ten of the secondary particles. An average of the ten values is adopted as the final ratio of opened pore. It should be noted that the resin embedding is carried out while sufficiently eliminating air present in the pores using a vacuum impregnation equipment (CitoVac, manufactured by Struers Ltd.).

[Mean Pore Size of Opened Pore (μm)]

The mean pore size of the opened pore is measured according to a mercury intrusion technique, using a mercury intrusion type pore size distribution measuring apparatus (apparatus name “Auto pore IV9510”, manufactured by SHIMADZU CORPORATION).

### [Oriented Ratio (%)]

The powders of the secondary particle are arranged on a glass substrate in such a manner that the secondary particles are not overlapped as much as possible, and thereafter, the powders are taken by an adhesive tape so that the powders are buried in the synthetic resin. The buried powders are polished in such a manner that the plate surfaces of or the polished sectional surface of the secondary particles can be observed, to obtain samples for observation. It should be noted that, when the plate surface is observed, a final polishing is performed using colloidal silica (0.05 μm) as an abrasive compound by a vibration type rotational sander. When the sectional surface is observed, the polishing is performed by a cross section polisher.

For the sample made accordingly, a crystal orientation analysis of each secondary particle is carried out, in the visual field in which ten or more of the primary particles in one secondary particle are visible, setting the pixel resolution of the measurement at 0.1 μm, by an EBSD (Electron Backscatter Diffraction Pattern: using measurement software “OIM Data Collection” and analyzing software “OIM Analysis”, both are made by TSL solutions Ltd.). By the analysis, an angle of the (003) plane of each of the primary particles with respect to the measured surface (polished surface) is obtained.

A histogram (angle distribution) of the number of particles with respect to angle is output, an angle at which the number of the primary particles is maximum (i.e., peak value) is defined/obtained as a (003) plane inclined angle δ with respect to the measured surface of the secondary particle. Thereafter, the number of primary particles, each of which (003) plane is within θ±10 degree in the measured secondary particle, is calculated. The oriented ratio of the (003) plane of the measured secondary particle is calculated by dividing the thus obtained number of primary particles by the number of all of the primary particles in the secondary particle. This operation is carried out for ten of the different secondary particles. An average of the ten values is adopted as the oriented ratio of the (003) plane.

### [Rate Capacity Maintenance Ratio (%)]

For an evaluation of the cell characteristics, a coin cell is made as described below.

A cathode active material paste is prepared by mixing the obtained secondary particle powder, acetylene black, and polyvinylidene fluoride (PVDF) with a mass ratio of 90:5:5, and by dispersing it into N-methyl-2-pyrolidone. The paste is applied onto an aluminum foil whose thickness is 20 μm serving as the cathode collector in such a manner that the paste has a uniform thickness (thickness after dried is 50 μm). The dried sheet is punched to obtain a disk whose diameter is 14 mm. The disk is pressed under pressure of 2,000 kg/cm² to obtain the positive electrode plate. The coin cell as shown in FIG. 1 is made using the thus produced positive electrode plate.

It should be noted that the electrolytic solution is prepared by dissolving LiPF₆ in an organic solvent obtained by mixing ethylene carbonate (EC) and diethyl carbonate (DEC) at an equal volume ratio, in such a manner that a concentration of LiPF₆ coincides with 1 mol/L.

Using the thus prepared battery (coin cell) for characteristic evaluation, an evaluation of the rate capacity maintenance ratio is carried out by performing charge and discharge operations.

Firstly, a constant current charge is carried out until a battery voltage reaches 4.3 V at a rate current of 0.1 C. Thereafter, a constant-voltage charge is carried out under a current condition to maintain the battery voltage at 4.3 V until a current decreases to 1/20 of the initial current. After a ten minutes pause, a constant current discharge is carried out until the battery voltage reaches 2.5 V at a rate current of 0.1 C, and then, the battery is left for ten minutes. One cycle is defined to include those charge and discharge operations. Two cycles are carried out at a temperature of 25° C., and a measured value of a discharged capacity at the (end of) second cycle is adopted as a “discharge capacity at 0.1 C rate.”

Subsequently, fixing the current value at 0.1 C rate during the charge, and setting the current value at 5 C rate during the discharge, two cycles of charging and discharging are performed, similarly to the above. A measured value of the discharged capacity at the (end of) second cycle is adopted as a “discharge capacity at 5 C rate.”

A value (in actuality, the value expressed by percentage) obtained by dividing the “discharge capacity at 5 C rate” by the “discharge capacity at 0.1 C rate” is adopted as the “rate capacity maintenance ratio.”

### [Output Characteristic]

The constant current charge is carried out until the battery voltage reaches 4.3 V at the rate current of 0.1 C. Thereafter, the constant voltage charge is carried out under the current condition to maintain the battery voltage at 4.3 V until the current decreases to 1/20 of the initial current. After a ten minutes pause, the constant current discharge is carried out until the battery voltage reaches 2.5 V at the rate current of 5 C, and then, the battery is left for ten minutes. One cycle is defined to include those charge and discharge operations. Two cycles are carried out at a temperature of 25° C. The discharge capacity at (the end of) the second cycle is defined 100%. A discharge voltage when the discharge capacity reaches 90% (SOC 10%: SOC stands for “Stat Of Charge”, which indicates a charge state) is read out from a discharge curve. This read out value is used as an indication of the output characteristic. As the value becomes higher, the output characteristic is more excellent, and thus, the higher value is preferable.

### 5-1: Nickel Series Composition

### Example 1

### (1) Preparation of Raw Material and Slurry

Firstly, Ni(OH)₂ powder (supplied by KOJUNDO CHEMICAL LABORATORY Co. Ltd.), Co(OH)₂ powder (supplied by KOJUNDO CHEMICAL LABORATORY Co. Ltd.), and Al₂O₃.H₂O powder (supplied by SASOL Ltd.) are weighed in such a manner that a mole ratio of Ni, Co, Al is 80:15:5 in a mixture. Subsequently, a pore-forming agent (spherical shape: trade name “Bellpearl R100” supplied by AIR WATER INC.) is added to the weighed materials. The pore-forming agent is weighed in such a manner that a ratio of a weight of the agent to a total weight of the powder to which the agent has been added is 2%. Thereafter, the raw material powder is prepared by crushing/mixing the mixed powder to which the pore-forming agent has been added for 24 hours by a ball mill

100 parts of the prepared raw material powder, 400 parts of a pure water serving as a disperse media, one part of a binder (polyvinyl alcohol: part number VP-18, supplied by JAPAN VAM & POVAL CO., LTD.), one part of a dispersing agent (product name “MALIALIM KM-0521” supplied by NOF CORPORATION), and 0.5 part of a defoaming agent (1-octanol supplied by Wako Pure Chemical Industries, Ltd.) are mixed. Further, a slurry is prepared by stirring the mixture under reduced pressure for defoaming, and by adjusting a viscosity so that the viscosity coincides with 0.5 Pa·s (the viscosity is measured using LVT type viscometer supplied by Brookfield Engineering Laboratories, Inc.).

### (2) Formation and Heat Treatment (Calcination) of Raw Material Particle

The thus prepared slurry is formed into a sheet-like shape on a PET film according to doctor blade method in such a manner that it has a thickness of 25 μm after dried. The sheet-like compact obtained by taking out from the PET film after dried is put on a zirconia setter at a center position of the setter, a temperature of the compact is increased at 200° C./h under atmosphere, and is heated at 900° C. for three hours, so that the sheet-like (Ni_{0.8}CO_{0.15}Al_{0.05})O ceramics sheet is obtained.

### (3) Crushing (Cracking) Compact

The above described ceramics sheet obtained by the heat treatment (calcination) is put on a screen (mesh) having opening size of 30 μm, and then, is crushed by being made to pass through the mesh by being slightly pressed against the mesh with a paddle, so that (Ni_{0.8}CO_{0.15}Al_{0.05})O powder having a substantial spherical shape is obtained.

### (4) Spheroidizing and Classifying Crushed Product

The (Ni_{0.8}CO_{0.15}Al_{0.05})O powder obtained by being crushed is put into an air classifier (product name “Turbo Classifier”, Model TC-15: discharge air flow 1.7 m³/minute, classifier rotor rotation speed 10,000 rpm, supplied by Nisshin Engineering Inc.) at a rate of 20 g/minute, and classified coarser powder among the obtained powder are obtained. This spheroidizing treatment (which simultaneously classifies the powder by eliminating minute particles) is repeated five times.

(5) Mixing with Lithium Compound

The (Ni_{0.8}Co_{0.15}Al_{0.05})O powder obtained after eliminating the minute particles and LiOH.H₂O powder (supplied by Wako Pure Chemical Industries, Ltd.) are mixed in such a manner that a mole ratio of Li/((Ni_{0.8}CO_{0.15}Al_{0.05}) becomes equal to 1.05.

### (6) Firing Process (Introducing Lithium Process)

The mixed powder is put into a high purity alumina crucible, and is heat-treated at 775° C. for 24 hours under oxygen atmosphere (0.1 MPa) so as to obtain Li(Ni_{0.8}CO_{0.15}Al_{0.05})O₂ (example 1).

### Examples 2-10, and Comparative Examples 1-3

Examples 2-10, and Comparative Examples 1-3 are obtained by changing a kind and an additive amount of the pore-forming agent, forming method, with or without the calcination, conditions of the calcination, an opening size of the mesh when crushing, with or without spheroidizing, with respect to the manufacturing method for the example 1 described above (refer to table 1).

In table 1, a sample whose pore-forming agent is spherical shape was made using the same pore-forming agent as the agent used for the example 1. In contrast, a sample whose pore-forming agent is fibrous shape was made using, as the pore-forming agent, an agent whose trade name is “Celish PC110S” supplied by Daicel FineChem Ltd.

Forming process of powder in the example 2 using spray drying in place of tape casting is carried out as follows: granulated powders having spherical shapes are obtained by using spray drier (turning type model number TSR-3W supplied by Sakamotogiken Co., LTD.) under the condition that a liquid rate is 40 g/minute, an inlet temperature is 200° C., and a n atomizer rotation speed is 13,000 rpm.

Classifying process is performed for the examples which have been produced without going through the spheroidizing process, according to the following process: 100 parts of the powder and 500 parts of ethanol are mixed and dispersed in such a manner that the powder particles are not broken to much extent using an ultrasonic disperser (ultrasonic cleaner), or the like. Thereafter, the dispersed liquid are made to pass through a screen (mesh) having opening size of 5 μm, and the powders remaining on the screen is dried at 150° C. for 5 hours so as to eliminate the minute powders equal to or smaller than 5 μm generated through the crushing process.

### Example 11

The preparation of the raw material and the slurry for the example 11 are carried out as follows, and the other processes are the same as ones for the example 1.

Firstly, Ni(OH)₂ powder (supplied by KOJUNDO CHEMICAL LABORATRY Co. Ltd.), Co(OH)₂ powder (supplied by KOJUNDO CHEMICAL LABORATRY Co. Ltd.), and Al₂O₃.H₂O (supplied by SASOL Ltd.) are weighed in such a manner that a mole ratio of Ni, Co, Al is 80:15:5 in a mixture. Subsequently, a pore-forming agent (spherical shape: trade name “Bellpearl R100” supplied by AIR WATER INC.) is added to the weighed materials. The pore-forming agent is weighed in such a manner that a ratio of a weight of the agent to a total weight of the powder to which the agent has been added is 8%. Thereafter, the raw material powder is prepared by crushing/mixing the mixed powder to which the pore-forming agent has been added for 24 hours by a ball mill

100 parts of the prepared raw material powder, 100 parts of a disperse media (toluene:isopropyl alcohol=1:1, by weight ratio), 10 parts of a binder (polyvinyl butyral: part number BM-2, supplied by SEKISUI CHEMICAL CO., LTD.): 4 parts of plasticizer (phthalic bis(2-ethylhexyl): alias dioctyl phthalate (abbreviated name DOP) supplied by Kurogane Kasei Co., Ltd.), 2 parts of a dispersing agent (product name “RHEODOL SP-O30” supplied by Kao Corporation) are mixed. Further, a slurry is prepared by stirring the mixture under reduced pressure for defoaming, and by adjusting a viscosity so that the viscosity coincides with 3-4 Pa·s.

The manufacturing conditions for the examples 1-11, and the comparative examples 1-4 are shown in Table 1, and evaluation results of those are shown in Table 2 and Table 3.

TABLE 1

| | | | | | feed speed | | | | mesh | |
|---|---|---|---|---|---|---|---|---|---|---|
| | | | additive amount | | when | rate of | | | opening | |
| | | pore-forming | of pore-forming | forming | forming | temperature | | firing | size | |
| | Material | material | material | method | (m/s) | increase | calcination | temperature | (μm) | spheroidizing |
| Example 1 | Ni series | spherical | 2 | tape | 1 | 200 | with | 775 | 30 | air classifying |
| | | | | casting | | | | | | |
| Example 2 | Ni series | spherical | 20 | tape | 1 | 200 | without | 775 | 30 | air classifying |
| | | | | casting | | | | | | |
| Example 3 | Ni series | spherical | 7 | tape | 1 | 400 | without | 750 | 25 | air classifying |
| | | | | casting | | | | | | |
| Example 4 | Ni series | none | — | tape | 1 | 400 | without | 750 | 25 | air classifying |
| | | | | casting | | | | | | |
| Example 5 | Ni series | fibrous | 7 | tape | 1 | 50 | without | 775 | 25 | air classifying |
| | | | | casting | | | | | | |
| Example 6 | Ni series | spherical | 13 | tape | 1 | 200 | with | 750 | 25 | air classifying |
| | | | | casting | | | | | | |
| Example 7 | Ni series | spherical | 14 | tape | 0.1 | 50 | without | 750 | 25 | air classifying |
| | | | | casting | | | | | | |
| Example 8 | Ni series | spherical | 14 | tape | 0.5 | 200 | without | 750 | 25 | air classifying |
| | | | | casting | | | | | | |
| Example 9 | Ni series | fibrous | 14 | tape | 1 | 200 | with | 750 | 25 | — |
| | | | | casting | | | | | | |
| Example 10 | Ni series | fibrous | 13 | tape | 1 | 200 | with | 750 | 25 | air classifying |
| | | | | casting | | | | | | |
| Example 11 | Ni series | spherical | 8 | tape | 1 | 50 | without | 750 | 25 | air classifying |
| | | | | casting | | | | | | |
| Comparative 1 | Ni series | spherical | 7 | tape | 1 | 50 | with | 725 | 25 | air classifying |
| | | | | casting | | | | | | |
| Comparative 2 | Ni series | fibrous | 7 | spray | — | 200 | with | 750 | — | — |
| | | | | dry | | | | | | |
| Comparative 3 | Ni series | none | — | tape | 1 | 400 | with | 775 | 25 | air classifying |
| | | | | casting | | | | | | |
| Comparative 4 | Ni series | spherical | 2 | tape | 1 | 200 | without | 800 | 25 | air classifying |
| | | | | casting | | | | | | |

TABLE 2

| | Powder characteristics | | | | | | | | |
|---|---|---|---|---|---|---|---|---|---|
| | primary | secondary | aspect | aspect | | ratio of | mean | mean particle | |
| | article | article | ratio of | ratio of | | opened | pore | size of primary | oriented |
| | size | size | primary | secondary | voidage | pore | size | particle/mean | ratio |
| | (μm) | (μm) | article | article | (%) | (%) | (μm) | pore size | (%) |
| Example 1 | 1.1 | 17 | 1.2 | 1.2 | 4 | 70 | 1.2 | 0.9 | 75 |
| Example 2 | 1.3 | 17 | 1.3 | 1.1 | 28 | 95 | 1.3 | 1.0 | 75 |
| Example 3 | 0.8 | 14 | 1.2 | 1.1 | 11 | 85 | 5.0 | 0.2 | 75 |
| Example 4 | 0.7 | 14 | 1.1 | 1.2 | 12 | 85 | 0.2 | 3.5 | 75 |
| Example 5 | 2.5 | 16 | 1.4 | 1.2 | 10 | 85 | 1.2 | 2.1 | 75 |
| Example 6 | 0.8 | 14 | 1.2 | 1.1 | 19 | 95 | 1.1 | 0.7 | 75 |
| Example 7 | 0.7 | 13 | 1.1 | 1.1 | 20 | 95 | 1.2 | 0.6 | 90 |
| Example 8 | 0.7 | 14 | 1.2 | 1.2 | 20 | 95 | 1.1 | 0.6 | 60 |
| Example 9 | 0.8 | 13 | 1.2 | 1.4 | 20 | 95 | 1.0 | 0.8 | 75 |
| Example 10 | 0.8 | 15 | 1.2 | 1.3 | 19 | 95 | 1.8 | 0.4 | 75 |
| Example 11 | 0.8 | 14 | 1.3 | 1.2 | 11 | 90 | 0.7 | 1.1 | 75 |
| Comparative 1 | 0.3 | 17 | 1.3 | 1.1 | 11 | 90 | 4.0 | 0.08 | 75 |
| Comparative 2 | 0.8 | 14 | 1.2 | 1.1 | 10 | 90 | 0.7 | 1.1 | 0 |
| Comparative 3 | 1.0 | 13 | 1.2 | 1.2 | 2 | <10 | 0.2 | 5.0 | 75 |
| Comparative 4 | 5.0 | 15 | 1.5 | 1.3 | 5 | 20 | 0.6 | 8.3 | 75 |

TABLE 3

cell characteristics

| | capacity | voltage at SOC 10% |
|---|---|---|
| | maintenance ratio (%) | (V) |
| Example 1 | 85.9 | 3.51 |
| Example 2 | 86.1 | 3.53 |
| Example 3 | 86.2 | 3.52 |
| Example 4 | 85.7 | 3.51 |
| Example 5 | 85.7 | 3.51 |
| Example 6 | 87.1 | 3.56 |
| Example 7 | 88.2 | 3.58 |
| Example 8 | 85.8 | 3.51 |
| Example 9 | 86.2 | 3.52 |
| Example 10 | 86.9 | 3.55 |
| Example 11 | 87.0 | 3.55 |
| Comparative 1 | 83.6 | 3.44 |
| Comparative 2 | 83.2 | 3.43 |
| Comparative 3 | 82.9 | 3.44 |
| Comparative 4 | 83.1 | 3.44 |

### 5-2: Three Way Composition

### Example 12•Comparative Example 5

When preparing the example 12, weighing condition for preparing the raw material particles and firing (introducing lithium) condition are changed as follows so as to obtain Li(Ni_{0.33}CO_{0.33}Mn_{0.33})O₂ powder. Further, the forming process for the example 12 is replaced with the spray drying so as to prepare the comparative example 5.

When preparing the raw material particles, Ni(OH)₂ powder (supplied by KOJUNDO CHEMICAL LABORATRY Co. Ltd.), Co(OH)₂ powder (supplied by KOJUNDO CHEMICAL LABORATRY Co. Ltd.), and MnCO₃ powder (supplied by Tosoh corporation) are weighed in such a manner that a mole ratio of Ni, Co, Al is 0.33:0.33:0.33 in a mixture. Further, during the firing (introduction of lithium) process, the mixed powder is heat treated at 950° C. for 12 hours under atmosphere (0.02 MPa).

### 5-3: Solid Solution Composition

### Example 13•Comparative Example 6

When preparing the example 13, preparing condition for preparing the raw material particles is changed as follows so as to produce the solid solution type secondary particle powder. Further, the forming process for the example 13 is replaced with the spray drying so as to prepare the comparative example 6.

Sulfate mixed water solution containing Ni, Co, and Mn is synthesized in such a manner that a mole ratio of Co, Ni, Mn is 16.3:16.3:67.5 in a mixture, and the synthesized sulfate mixed water solution is reacted with NaOH in a hot water whose temperature is 50° C. so as to obtain coprecipitated hydroxide. The obtained coprecipitated hydroxide is crushed and mixed for 16 hours in a ball mill so as to obtain the raw material particle powder. As for the example 13, bismuth oxide (supplied by TAIYO KOKO Co., Ltd.) is further added to the raw material particle powder in such a manner that bismuth oxide is included at 0.5 wt % with respect to a total weight after it is added (as for the comparative example 6, such a addition of bismuth oxide is not carried out).

The manufacturing conditions for the examples 12, and 13, as well as the comparative examples 5, and 6 are shown in Table 4, and evaluation results of those are shown in Table 5 and Table 6. It should be noted that, when evaluating the rate capacity maintenance ratio of the example 13 and the comparative example 6, “4.3 V” is changed to “4.8 V”, and the “2.5 V” is changed to “2.0 V”, during the above described charge and discharge operation.

TABLE 4

| | | | | | feed speed | | | | mesh | |
|---|---|---|---|---|---|---|---|---|---|---|
| | | pore- | additive amount of | | when | rate of | | | opening | |
| | | forming | pore-forming | forming | forming | temperature | | firing | size | |
| | Material | material | material | method | (m/s) | increase | calcination | temperature | (μm) | spheroidizing |
| Example 12 | Three way | spherical | 15 | tape | 1 | 200 | without | 850 | 25.0 | air classifying |
| | | | | casting | | | | | | |
| Comparative 5 | Three way | spherical | 3 | spray | — | 200 | without | 900 | — | — |
| | | | | dry | | | | | | |
| Example 13 | Solid | fibrous | 10 | tape | 1 | 200 | without | 900 | 25.0 | air classifying |
| | solution | | | casting | | | | | | |
| Comparative 6 | Solid | none | — | tape | 1 | 200 | with | 1000 | 25.0 | air classifying |
| | solution | | | casting | | | | | | |

TABLE 5

| | Powder characteristics | | | | | | | | |
|---|---|---|---|---|---|---|---|---|---|
| | primary | secondary | aspect | aspect | | ratio of | mean | mean particle | |
| | article | article | ratio of | ratio of | | opened | pore | size of primary | oriented |
| | size | size | primary | secondary | voidage | pore | size | particle/mean | ratio |
| | (μm) | (μm) | article | article | (%) | (%) | (μm) | pore size | (%) |
| Example 12 | 0.8 | 14 | 1.2 | 1.2 | 20 | 95 | 1.1 | 0.7 | 75 |
| Comparative 5 | 1.2 | 13 | 1.3 | 1.1 | 5 | 20 | 1.0 | 1.2 | 0 |
| Example 13 | 0.2 | 12 | 1.2 | 1.3 | 25 | 95 | 1.0 | 0.2 | 75 |
| Comparative 6 | 1.2 | 12 | 1.4 | 1.3 | 5 | 20 | 0.2 | 6.0 | 75 |

TABLE 6

cell characteristics

| | capacity | voltage at SOC 10% |
|---|---|---|
| | maintenance ratio (%) | (V) |
| Example 12 | 86.1 | 3.51 |
| Comparative 5 | 82.2 | 3.43 |
| Example 13 | 69.5 | 2.51 |
| Comparative 6 | 42.1 | 2.20 |

### 6. MODIFICATIONS

The above-described embodiment and specific examples are, as mentioned above, mere examples of the best mode of the present invention which the applicant of the present invention contemplated at the time of filing the present application. The above-described embodiment and specific examples should not be construed as limiting the invention. Various modifications to the above-described embodiment and specific examples are possible, so long as the invention is not modified in essence.

Several modifications will next be exemplified. In the following description of the modifications, component members similar in structure and function to those of the above-described embodiment are denoted by names and reference numerals identical to those of the above-described embodiment. The description of the component members appearing in the above description of the embodiment can be applied as appropriate, so long as no inconsistencies are involved.

Needless to say, even modifications are not limited to those described below. Limitingly construing the present invention based on the above-described embodiment and the following modifications impairs the interests of an applicant (particularly, an applicant who is motivated to file as quickly as possible under the first-to-file system) while unfairly benefiting imitators, and is thus impermissible.

The structure of the above-described embodiment and the structures of the modifications to be described below are entirely or partially applicable in appropriate combination, so long as no technical inconsistencies are involved.

The structure of the lithium secondary battery 1 to which the present invention is applicable is not limited to the structure described above. For example, the present invention is not limited to the specific cell structure described above. That is, for example, the present invention can preferably be applied to a cylindrical lithium secondary battery having a core. Also, the present invention is not limited to the liquid-type cell structure. That is, for example, as the electrolyte, a gel electrolyte, and a polymer electrolyte may be used.

Another compound may be present in the pores V. For example, when the electrolyte, electrical conducting material such as acetylene black, and the like, another lithium ion cathode active material having an excellent rate characteristic, another cathode active material having different particle size are present in the pores V, the rate characteristic and a cycle characteristic are further improved. A method for having another compounds be present in the pores V includes a method including applying a chemical compound to a surface of the pore-forming agent beforehand, and then adjusting the firing condition, a method including mixing a chemical compound into the raw material particles when forming the cathode active material particles 222, or the like. A conductivity agent added to the electrode such as acetylene black, and the like can be introduced into the pores by adjusting conditions when producing the electrode. For example, low-viscosity ink in which the acetylene black is dispersed is mixed with the cathode active material particles in vacuum, and thereafter, the ambient pressure is returned to atmospheric pressure, to thereby press the ink into the pores by a differential pressure. A method may be used which includes modifying a surface of the inner wall of the opened pore of the cathode active material particle in such a manner that the surface has a strong affinity for acetylene black or its disperse solution. It should be noted that the opened pore preferably has a structure such that it communicates with an outer surface of the powder in different directions instead of a structure such that it has a dead end, because such structure can allow the ink or the electrolytic solution to easily penetrate into the pores.

Further, the surface of the single-crystalline primary particle 222a, or the surface of the cathode active material particle 222 may be coated with another material. Depending on the material coating those surfaces, a thermal stability or a chemical stability of the particles may be improved, or the rate characteristic may be improved. As the coating material, the followings may be used, for example. Chemically stable alumina, zirconia, alumina fluoride, or the like; a material in which lithium can readily be diffused, such as lithium cobaltate; carbon having an excellent electron conductivity.

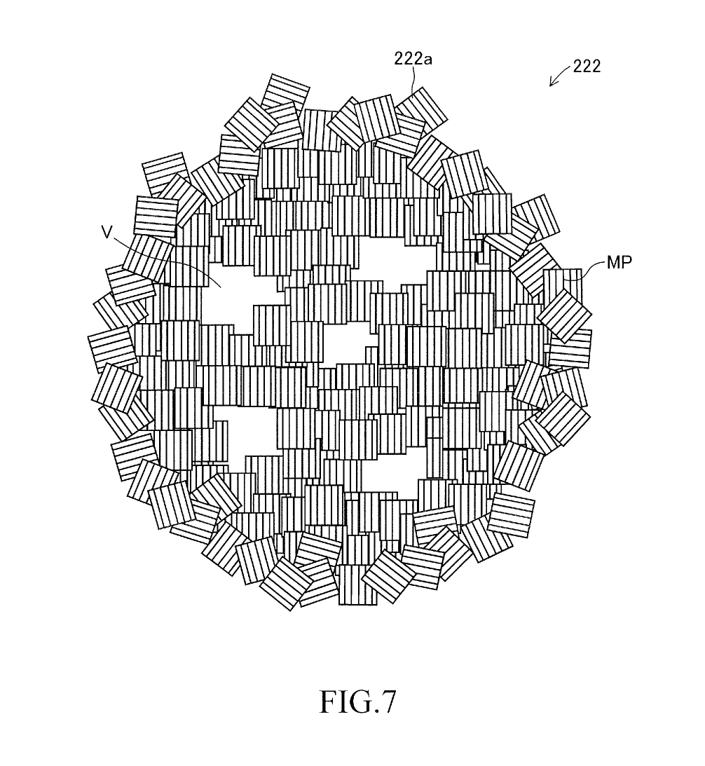

FIG. 7 is a view showing one modified example of the cathode active material particle 222 shown in FIG. 3. As shown in FIG. 7, a degree of orientation may be lower in a surface part than in an inner part in the cathode active material particle 222. That is, the single-crystalline primary particles 222a of the cathode active material particle 222 according to the present modification have random orientations only in the surface part of the cathode active material particle 222.

According to such a structure, even in an area that has a surface in which the (003) plane through which lithium ions and electrons are hard to intercalate and deintercalate is widely exposed to the outside, the intercalation and deintercalation of lithium ions readily occur between the single-crystalline primary particle 222a and the electrolyte outside of the particles 222a, and thus, the rate characteristic is improved. For example, such a surface part may be formed by reattaching the minute powders generated during the crushing process or the spheroidizing process to the particles (this can be realized by appropriately adjusting the conditions of the crushing process or the spheroidizing process). It should be noted that such a minute structure in the particle can be evaluated by using EBSD (electron backscatter diffraction image technique) in the SEM observation or the crystal orientation analysis in the TEM observation for a cross-section surface (processed using cross section polisher, ion beam, or the like) of the secondary particle.

The present invention is not limited to the specific manufacturing method described above. For example, the forming process is not limited to the forming process described above. The firing (introduction of lithium) process may be omitted by appropriately selecting the materials before the forming process.

Further, even when the oxidation products are used as the raw material particles, the precursor particle 704 for the cathode active material in which the raw material particles are oriented (filled into the compact in such a manner that crystal orientations coincide with each other) may be obtained by applying a magnetic field when forming. Accordingly, the present invention is not limited to a case in which hydroxide products are used as the raw material particles.

Needless to say, those modifications which are not particularly referred to are also encompassed in the technical scope of the present invention, so long as the invention is not modified in essence.

Those components which partially constitute means for solving the problems to be solved by the present invention and are expressed using operations and functions encompass not only the specific structures disclosed above in the description of the above embodiment and modifications but also any other structures that can implement the operations and functions. Further, the contents (including specifications and drawings) of the prior application and publications cited herein can be incorporated herein as appropriate by reference.

1. A cathode active material having a layered rock salt structure for a lithium secondary battery, wherein,
said cathode active material includes secondary particles, each being formed of a large number of primary particles whose mean particle size is equal to or larger than 0.01 μm and equal to or smaller than 5 μm;
said secondary particle has,
an oriented ratio of a (003) plane which is equal to or larger than 60%;
a mean particle size which is equal to or larger than 1 μm and equal to or smaller than 100 μm;
an aspect ratio which is equal to or larger than 1.0 and is smaller than 2, said aspect ratio being obtained through dividing a longitudinal axis size of said secondary particle by a short axis size of said secondary particle;
a voidage which is equal to or larger than 3% and equal to or smaller than 30%;
a ratio of opened pore which is equal to or larger than 70%;
a mean pore size of said opened pore which is equal to or larger than 0.1 μm and equal to or smaller than 5 μm, and
a value which is equal to or larger than 0.1 and equal to or smaller than 5, said value being obtained through dividing said mean particle size of said primary particle by said mean pore size of said opened pore.

2. The cathode active material for a lithium secondary battery according to claim 1, wherein said oriented ratio is equal to or larger than 75%.

3. The cathode active material for a lithium secondary battery according to claim 1, wherein said aspect ratio of said secondary particle is equal to or larger than 1.1 and is smaller than 1.5.

4. A lithium secondary battery having a cathode including a cathode active material layer, and a anode including a anode active material layer, wherein,
said cathode active material layer includes a cathode active material which is formed as a secondary particle in such a manner that a large number of single-crystalline primary particles, each being lithium composite oxide having a layered rock salt structure, congregate;
said primary particle has a mean particle size which is equal to or larger than 0.01 μm and equal to or smaller than 5 μm;
said secondary particle has,
an oriented ratio of a (003) plane which is equal to or larger than 60%;
a mean particle size which is equal to or larger than 1 μm and equal to or smaller than 100 μm;
an aspect ratio which is equal to or larger than 1.0 and is smaller than 2, said aspect ratio being obtained through dividing a longitudinal axis size of said secondary particle by a short axis size of said secondary particle;
a voidage which is equal to or larger than 3% and equal to or smaller than 30%;
a ratio of opened pore which is equal to or larger than 70%;
a mean pore size of said opened pore which is equal to or larger than 0.1 μm and equal to or smaller than 5 μm; and
a value which is equal to or larger than 0.1 and equal to or smaller than 5, said value being obtained through dividing said mean particle size of said primary particle by said mean pore size of said opened pore.

5. The lithium secondary battery according to claim 4, wherein said oriented ratio is equal to or larger than 75%.

6. The lithium secondary battery according to claim 4, wherein said aspect ratio is equal to or larger than 1.1 and is smaller than 1.5.

7. The cathode active material for a lithium secondary battery according to claim 2, wherein said aspect ratio of said secondary particle is equal to or larger than 1.1 and is smaller than 1.5.

8. The lithium secondary battery according to claim 5, wherein said aspect ratio is equal to or larger than 1.1 and is smaller than 1.5.
